(19) United States
(12) Patent Application Publication
(10) Pub. No.: US 2020/0374516 A1
(43) Pub. Date: Nov. 26, 2020

(54) IMAGE DECODING METHOD AND APPARATUS BASED ON EFFICIENT TRANSFORMATION OF CHROMA COMPONENT IN IMAGE CODING SYSTEM

(71) Applicant: LG Electronics Inc., Seoul (KR)

(72) Inventors: Jin HEO, Seoul (KR); Junghak NAM, Seoul (KR); Sunmi YOO, Seoul (KR); Jangwon CHOI, Seoul (KR)

(21) Appl. No.: 16/769,429

(22) PCT Filed: Dec. 4, 2017
(86) PCT No.: PCT/KR2017/014072

§ 371 Date: Jun. 3, 2020

(51) Int. Cl. H04N 19/11; H04N 19/176; H04N 19/186; H04N 19/61; H04N 19/44; H04N 19/625

(52) U.S. Cl. CPC H04N 19/11; H04N 19/176; H04N 19/625; H04N 19/61; H04N 19/44; H04N 19/186

(57) ABSTRACT

An image decoding method performed by a decoding apparatus according to the present disclosure comprises a step of obtaining information on an intra prediction mode of a current chroma block and a transform coefficients, a step of generating a prediction sample based on the intra prediction mode of the current chroma block, a step of generating a residual sample using the transform coefficients of the current chroma block based on the transform information of the corresponding luma block of the current chroma block, and a step of generating a reconstruction sample based on the prediction sample and the residual sample.

### CROSS-REFERENCE TO RELATED APPLICATIONS

This application is the National Stage filing under 35 U.S.C. 371 of International Application No. PCT/KR2017/014072, filed on Dec. 4, 2017, the contents of which are hereby incorporated by reference herein in their entirety.

### BACKGROUND OF THE DISCLOSURE

### Field of the Disclosure

The present disclosure relates to an image coding technology, and more particularly, to an image coding method and apparatus based on efficient transform of a chroma component in an image coding system.

### Related Art

Demand for high-resolution, high-quality images such High Definition (HD) images and Ultra High Definition (UHD) images have been increasing in various fields. As the image data has high resolution and high quality, the amount of information or bits to be transmitted increases relative to the legacy image data. Accordingly, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images

### SUMMARY

An object of the present disclosure is to provide a method and an apparatus for enhancing image coding efficiency.

Another object of the present disclosure is to provide a method and an apparatus for deriving transform information of a chroma block based on transform information of a luma block corresponding to the chroma block.

Still another object of the present disclosure is to provide a method and an apparatus for performing an adaptive multiple core transform and a non-separable secondary transform for a chroma block based on transform information of a luma block corresponding to the chroma block.

Yet another object of the present disclosure is to provide a method and an apparatus for performing linear interpolation prediction for a chroma block based on whether to perform the linear interpolation prediction for a luma block corresponding to the chroma block.

An exemplary embodiment of the present disclosure provides a video decoding method performed by a decoding apparatus. The method includes obtaining transform coefficients and information about an intra prediction mode of a current chroma block, generating a predicted sample based on the intra prediction mode of the current chroma block, generating a residual sample using the transform coefficients of the current chroma block based on transform information of a corresponding luma block of the current chroma block, and generating a reconstructed sample based on the predicted sample and the residual sample.

Another exemplary embodiment of the present disclosure provides a decoding apparatus performing video decoding. The decoding apparatus includes an entropy decoder configured to obtain transform coefficients and information about an intra prediction mode of a current chroma block, a predictor configured to generate a predicted sample based on the intra prediction mode of the current chroma block, and to generate a residual sample by using the transform coefficients of the current chroma block based on transform information of a corresponding luma block of the current chroma block, and a reconstructor configured to generate a reconstructed sample based on the predicted sample and the residual sample.

Still another exemplary embodiment of the present disclosure provides a video encoding method performed by an encoding apparatus. The method includes determining an intra prediction mode of a current chroma block, generating a predicted sample and a residual sample based on the intra prediction mode of the current chroma block, generating transform coefficients by using the residual sample of the current chroma block based on transform information of a corresponding luma block of the current chroma block, and encoding and transmitting the transform coefficients and prediction information about the current chroma block.

Yet another exemplary embodiment of the present disclosure provides a video encoding apparatus. The encoding apparatus includes a predictor configured to determine an intra prediction mode of a current chroma block, and to generate a predicted sample and a residual sample based on the intra prediction mode of the current chroma block, a transformer configured to generate transform coefficients by using the residual sample of the current chroma block based on transform information of a corresponding luma block of the current chroma block, and an entropy encoder configured to encode and transmits the transform coefficients and the prediction information about the current chroma block.

According to the present disclosure, it is possible to perform the transform of the current chroma block based on the transform information of the corresponding luma block having the same block structure, thereby reducing the amount of bits used for transforming the current chroma block, and improving the overall coding efficiency.

According to the present disclosure, it is possible to perform the linear interpolation prediction for the current chroma block based on whether to perform the linear interpolation prediction for the corresponding luma block having the same block structure, thereby reducing the amount of bits used for predicting the current chroma block, and improving the overall coding efficiency.

### BRIEF DESCRIPTION OF THE DRAWINGS

FIG. 1 is a schematic diagram illustrating a configuration of a video encoding apparatus to which the present disclosure is applicable.

FIG. 2 is a schematic diagram illustrating a configuration of a video decoding apparatus to which the present disclosure is applicable.

FIG. 3 illustrates intra-directional modes of 65 prediction directions

FIG. 4 illustrates an example of a coding unit which is split into a QT structure or a QTBT structure.

FIG. 5 illustrates an example in which a luma component and a chroma component of a block within a picture are split through block split structures different from each other.

FIG. 6 illustrates an example in which the luma component and the chroma component of the block within the picture are split through the same block split structure.

FIG. 7 illustrates an example in which an adaptive multiple core transform is applied to a current chroma block if the luma component and the chroma component have the same block split structure.

FIG. 8 illustrates an example in which the adaptive multiple core transform is applied to a current block to be currently encoded.

FIG. 9 schematically illustrates a video encoding method by an encoding apparatus according to the present disclosure.

FIG. 10 schematically illustrates a video decoding method by a decoding apparatus according to the present disclosure.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be split into plural elements. The embodiments in which the elements are combined and/or split belong to the disclosure without departing from the concept of the disclosure.

Hereinafter, embodiments of the present disclosure will be described in detail with reference to the accompanying drawings. Further, like reference numerals are used to indicate like elements throughout the drawings, and the same descriptions on the like elements will be omitted.

In the present specification, generally a picture means a unit representing an image at a specific time, a slice is a unit constituting a part of the picture. One picture may be composed of plural slices, and the terms of a picture and a slice may be mixed with each other as occasion demands.

A pixel or a pel may mean a minimum unit constituting one picture (or image). Further, a “sample” may be used as a term corresponding to a pixel. The sample may generally represent a pixel or a value of a pixel, may represent only a pixel (a pixel value) of a luma component, and may represent only a pixel (a pixel value) of a chroma component.

A unit indicates a basic unit of image processing. The unit may include at least one of a specific area and information related to the area. Optionally, the unit may be mixed with terms such as a block, an area, or the like. In a typical case, an M×N block may represent a set of samples or transform coefficients arranged in M columns and N rows.

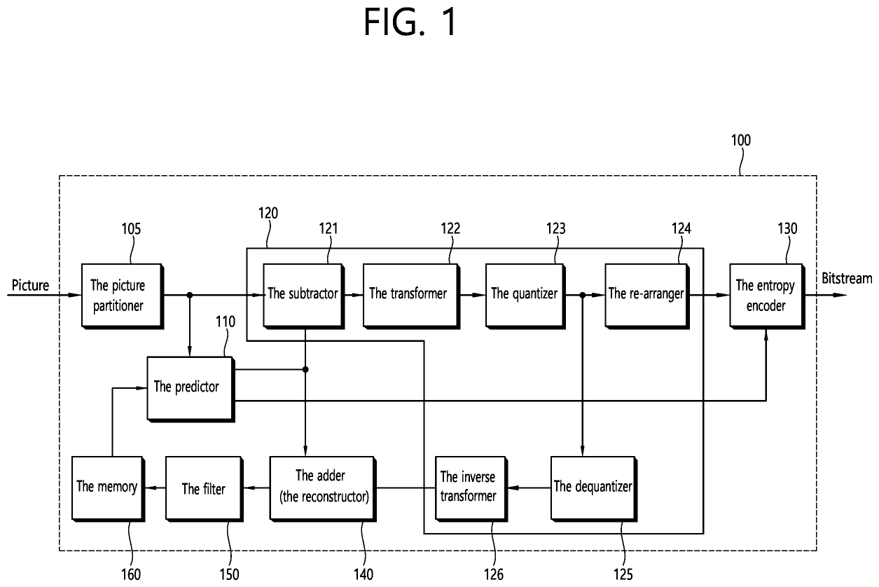

FIG. 1 is a schematic diagram illustrating a configuration of a video encoding apparatus to which the present disclosure is applicable.

Referring to FIG. 1, a video encoding apparatus (100) may include a picture partitioner (105), a predictor (110), a residual processor (120), an adder (140), a filter (150), and a memory (160). The residual processor (120) may include a subtractor (121), a transformer (122), a quantizer (123), a re-arranger (124), a dequantizer (125), an inverse transformer (126).

The picture partitioner (105) may split an input picture into at least one processing unit.

In an example, the processing unit may be referred to as a coding unit (CU). In this case, the coding unit may be recursively split from the largest coding unit (LCU) according to a quad-tree binary-tree (QTBT) structure. For example, one coding unit may be split into a plurality of coding units of a deeper depth based on a quadtree structure and/or a binary tree structure. In this case, for example, the quad tree structure may be first applied and the binary tree structure may be applied later. Alternatively, the binary tree structure may be applied first. The coding procedure according to the present disclosure may be performed based on a final coding unit which is not split any further. In this case, the largest coding unit may be used as the final coding unit based on coding efficiency, or the like, depending on image characteristics, or the coding unit may be recursively split into coding units of a lower depth as necessary and a coding unit having an optimal size may be used as the final coding unit. Here, the coding procedure may include a procedure such as prediction, transform, and reconstruction, which will be described later.

In another example, the processing unit may include a coding unit (CU) prediction unit (PU), or a transform unit (TU). The coding unit may be split from the largest coding unit (LCU) into coding units of a deeper depth according to the quad tree structure. In this case, the largest coding unit may be directly used as the final coding unit based on the coding efficiency, or the like, depending on the image characteristics, or the coding unit may be recursively split into coding units of a deeper depth as necessary and a coding unit having an optimal size may be used as a final coding unit. When the smallest coding unit (SCU) is set, the coding unit may not be split into coding units smaller than the smallest coding unit. Here, the final coding unit refers to a coding unit which is partitioned or split to a prediction unit or a transform unit. The prediction unit is a unit which is partitioned from a coding unit, and may be a unit of sample prediction. Here, the prediction unit may be split into sub-blocks. The transform unit may be split from the coding unit according to the quad-tree structure and may be a unit for deriving a transform coefficient and/or a unit for deriving a residual signal from the transform coefficient. Hereinafter, the coding unit may be referred to as a coding block (CB), the prediction unit may be referred to as a prediction block (PB), and the transform unit may be referred to as a transform block (TB). The prediction block or prediction unit may refer to a specific area in the form of a block in a picture and include an array of predicted samples. Also, the transform block or transform unit may refer to a specific area in the form of a block in a picture and include the transform coefficient or an array of residual samples.

The predictor (110) may perform prediction on a processing target block (hereinafter, a current block), and may generate a predicted block including predicted samples for the current block. A unit of prediction performed in the predictor (110) may be a coding block, or may be a transform block, or may be a prediction block.

The predictor (110) may determine whether intra-prediction is applied or inter-prediction is applied to the current block. For example, the predictor (110) may determine whether the intra-prediction or the inter-prediction is applied in unit of CU.

In case of the intra-prediction, the predictor (110) may derive a predicted sample for the current block based on a reference sample outside the current block in a picture to which the current block belongs (hereinafter, a current picture). In this case, the predictor (110) may derive the predicted sample based on an average or interpolation of neighboring reference samples of the current block (case (i)), or may derive the predicted sample based on a reference sample existing in a specific (prediction) direction as to a predicted sample among the neighboring reference samples of the current block (case (ii)). The case (i) may be called a non-directional mode or a non-angular mode, and the case (ii) may be called a directional mode or an angular mode. In the intra-prediction, prediction modes may include as an example 33 directional modes and at least two non-directional modes. The non-directional modes may include DC mode and planar mode. The predictor (110) may determine the prediction mode to be applied to the current block by using the prediction mode applied to the neighboring block.

In case of the inter-prediction, the predictor (110) may derive the predicted sample for the current block based on a sample specified by a motion vector on a reference picture. The predictor (110) may derive the predicted sample for the current block by applying any one of a skip mode, a merge mode, and a motion vector prediction (MVP) mode. In case of the skip mode and the merge mode, the predictor (110) may use motion information of the neighboring block as motion information of the current block. In case of the skip mode, unlike in the merge mode, a difference (residual) between the predicted sample and an original sample is not transmitted. In case of the MVP mode, a motion vector of the neighboring block is used as a motion vector predictor and thus is used as a motion vector predictor of the current block to derive a motion vector of the current block.

In case of the inter-prediction, the neighboring block may include a spatial neighboring block existing in the current picture and a temporal neighboring block existing in the reference picture. The reference picture including the temporal neighboring block may also be called a collocated picture (colPic). Motion information may include the motion vector and a reference picture index. Information such as prediction mode information and motion information may be (entropy) encoded, and then output as a form of a bitstream.

When motion information of a temporal neighboring block is used in the skip mode and the merge mode, a highest picture in a reference picture list may be used as a reference picture. Reference pictures included in the reference picture list may be aligned based on a picture order count (POC) difference between a current picture and a corresponding reference picture. A POC corresponds to a display order and may be discriminated from a coding order.

The subtractor (121) generates a residual sample which is a difference between an original sample and a predicted sample. If the skip mode is applied, the residual sample may not be generated as described above.

The transformer (122) transforms residual samples in units of a transform block to generate a transform coefficient. The transformer (122) may perform transform based on the size of a corresponding transform block and a prediction mode applied to a coding block or prediction block spatially overlapping with the transform block. For example, residual samples may be transformed using discrete sine transform (DST) transform kernel if intra-prediction is applied to the coding block or the prediction block overlapping with the transform block and the transform block is a 4×4 residual array and is transformed using discrete cosine transform (DCT) transform kernel in other cases.

The quantizer (123) may quantize the transform coefficients to generate quantized transform coefficients.

The re-arranger (124) rearranges quantized transform coefficients. The re-arranger (124) may rearrange the quantized transform coefficients in the form of a block into a one-dimensional vector through a coefficient scanning method. Although the re-arranger (124) is described as a separate component, the re-arranger (124) may be a part of the quantizer (123).

The entropy encoder (130) may perform entropy-encoding on the quantized transform coefficients. The entropy encoding may include an encoding method, for example, an exponential Golomb, a context-adaptive variable length coding (CAVLC), a context-adaptive binary arithmetic coding (CABAC), or the like. The entropy encoder (130) may perform encoding together or separately on information (e.g., a syntax element value or the like) required for video reconstruction Further to the quantized transform coefficients. The entropy-encoded information may be transmitted or stored in unit of a network abstraction layer (NAL) in a bitstream form.

The dequantizer (125) dequantizes values (transform coefficients) quantized by the quantizer (123) and the inverse transformer (126) inversely transforms values dequantized by the dequantizer (125) to generate a residual sample.

The adder (140) adds a residual sample to a predicted sample to reconstruct a picture. The residual sample may be added to the predicted sample in units of a block to generate a reconstructed block. Although the adder (140) is described as a separate component, the adder (140) may be a part of the predictor (110). Meanwhile, the adder (140) may be referred to as a reconstructor or reconstructed block generator.

The filter (150) may apply deblocking filtering and/or a sample adaptive offset to the reconstructed picture. Artifacts at a block boundary in the reconstructed picture or distortion in quantization may be corrected through deblocking filtering and/or sample adaptive offset. Sample adaptive offset may be applied in units of a sample after deblocking filtering is completed. The filter (150) may apply an adaptive loop filter (ALF) to the reconstructed picture. The ALF may be applied to the reconstructed picture to which deblocking filtering and/or sample adaptive offset has been applied.

The memory (160) may store a reconstructed picture (decoded picture) or information necessary for encoding/decoding. Here, the reconstructed picture may be the reconstructed picture filtered by the filter (150). The stored reconstructed picture may be used as a reference picture for (inter) prediction of other pictures. For example, the memory (160) may store (reference) pictures used for inter-prediction. Here, pictures used for inter-prediction may be designated according to a reference picture set or a reference picture list.

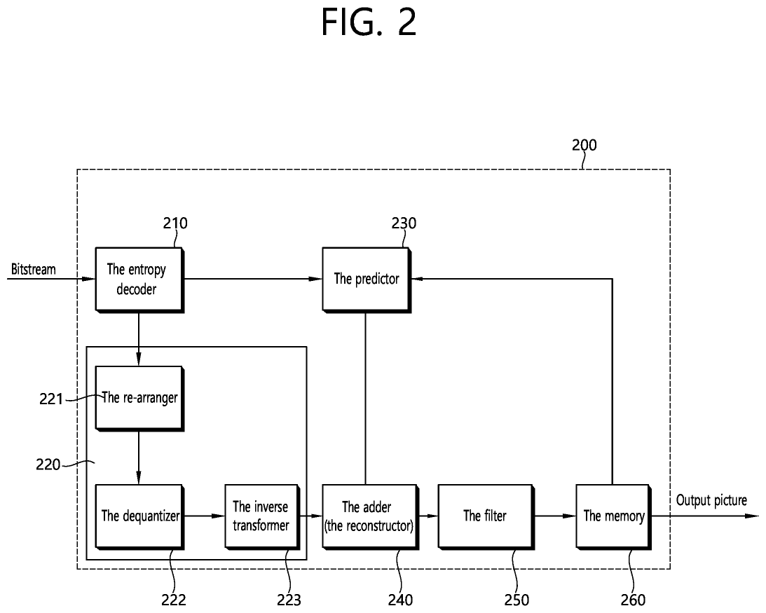

FIG. 2 is a schematic diagram illustrating a configuration of a video decoding apparatus to which the present disclosure is applicable.

Referring to FIG. 2, a video decoding apparatus (200) may include an entropy decoder (210), a residual processor (220), a predictor (230), an adder (240), a filter (250), and a memory (260). The residual processor (220) may include a re-arranger (221), a dequantizer (222), an inverse transformer (223).

When a bitstream including video information is input, the video decoding apparatus (200) may reconstruct a video in relation to a process by which video information is processed in the video encoding apparatus.

For example, the video decoding apparatus (200) may perform video decoding using a processing unit applied in the video encoding apparatus. Thus, the processing unit block of video decoding may be, for example, a coding unit and, in another example, a coding unit, a prediction unit or a transform unit. The coding unit may be split from the largest coding unit according to the quad tree structure and/or the binary tree structure.

A prediction unit and a transform unit may be further used in some cases, and in this case, the prediction block is a block derived or partitioned from the coding unit and may be a unit of sample prediction. Here, the prediction unit may be split into sub-blocks. The transform unit may be split from the coding unit according to the quad tree structure and may be a unit that derives a transform coefficient or a unit that derives a residual signal from the transform coefficient.

The entropy decoder (210) may parse the bitstream to output information required for video reconstruction or picture reconstruction. For example, the entropy decoder (210) may decode information in the bitstream based on a coding method such as exponential Golomb encoding, CAVLC, CABAC, or the like, and may output a value of a syntax element required for video reconstruction and a quantized value of a transform coefficient regarding a residual.

More specifically, a CABAC entropy decoding method may receive a bin corresponding to each syntax element in a bitstream, determine a context model using decoding target syntax element information and decoding information of neighboring and decoding target blocks or information of symbol/bin decoded in a previous step, predict bin generation probability according to the determined context model and perform arithmetic decoding of the bin to generate a symbol corresponding to each syntax element value. Here, the CABAC entropy decoding method may update the context model using information of a symbol/bin decoded for a context model of the next symbol/bin after determination of the context model.

Information on prediction among information decoded in the entropy decoder (210) may be provided to the predictor (230) and residual values, that is, quantized transform coefficients, on which entropy decoding has been performed by the entropy decoder (210) may be input to the re-arranger (221).

The re-arranger (221) may rearrange the quantized transform coefficients into a two-dimensional block form. The re-arranger (221) may perform rearrangement corresponding to coefficient scanning performed by the encoding apparatus. Although the re-arranger (221) is described as a separate component, the re-arranger (221) may be a part of the dequantizer (222).

The dequantizer (222) may de-quantize the quantized transform coefficients based on a (de)quantization parameter to output a transform coefficient. In this case, information about deriving a quantization parameter may be signaled from the encoding apparatus.

The inverse transformer (223) may inverse-transform the transform coefficients to derive residual samples.

The predictor (230) may perform prediction on a current block, and may generate a predicted block including predicted samples for the current block. A unit of prediction performed in the predictor (230) may be a coding block or may be a transform block or may be a prediction block.

The predictor (230) may determine whether to apply intra-prediction or inter-prediction based on information on a prediction. In this case, a unit for determining which one will be used between the intra-prediction and the inter-prediction may be different from a unit for generating a predicted sample. Further, a unit for generating the predicted sample may also be different in the inter-prediction and the intra-prediction. For example, which one will be applied between the inter-prediction and the intra-prediction may be determined in unit of CU. Further, for example, in the inter-prediction, the predicted sample may be generated by determining the prediction mode in unit of PU, and in the intra-prediction, the predicted sample may be generated in unit of TU by determining the prediction mode in unit of PU.

In case of the intra-prediction, the predictor (230) may derive a predicted sample for a current block based on a neighboring reference sample in a current picture. The predictor (230) may derive the predicted sample for the current block by applying a directional mode or a non-directional mode based on the neighboring reference sample of the current block. In this case, a prediction mode to be applied to the current block may be determined by using an intra-prediction mode of a neighboring block.

In the case of inter-prediction, the predictor (230) may derive a predicted sample for a current block based on a sample specified in a reference picture according to a motion vector. The predictor (230) may derive the predicted sample for the current block using one of the skip mode, the merge mode and the MVP mode. Here, motion information required for inter-prediction of the current block provided by the video encoding apparatus, for example, a motion vector and information on a reference picture index may be obtained or derived based on the information on prediction.

In the skip mode and the merge mode, motion information of a neighboring block may be used as motion information of the current block. Here, the neighboring block may include a spatial neighboring block and a temporal neighboring block.

The predictor (230) may construct a merge candidate list using motion information of available neighboring blocks and use information indicated by a merge index on the merge candidate list as a motion vector of the current block. The merge index may be signaled by the encoding apparatus. Motion information may include a motion vector and a reference picture. When motion information of a temporal neighboring block is used in the skip mode and the merge mode, a highest picture in a reference picture list may be used as a reference picture.

In the case of the skip mode, a difference (residual) between a predicted sample and an original sample is not transmitted, distinguished from the merge mode.

In the case of the MVP mode, the motion vector of the current block may be derived using a motion vector of a neighboring block as a motion vector predictor. Here, the neighboring block may include a spatial neighboring block and a temporal neighboring block.

When the merge mode is applied, for example, a merge candidate list may be generated using a motion vector of a reconstructed spatial neighboring block and/or a motion vector corresponding to a Col block which is a temporal neighboring block. A motion vector of a candidate block selected from the merge candidate list is used as the motion vector of the current block in the merge mode. The aforementioned information on prediction may include a merge index indicating a candidate block having the best motion vector selected from candidate blocks included in the merge candidate list. Here, the predictor (230) may derive the motion vector of the current block using the merge index.

When the MVP (Motion vector Prediction) mode is applied as another example, a motion vector predictor candidate list may be generated using a motion vector of a reconstructed spatial neighboring block and/or a motion vector corresponding to a Col block which is a temporal neighboring block. That is, the motion vector of the reconstructed spatial neighboring block and/or the motion vector corresponding to the Col block which is the temporal neighboring block may be used as motion vector candidates. The aforementioned information on prediction may include a prediction motion vector index indicating the best motion vector selected from motion vector candidates included in the list. Here, the predictor (230) may select a prediction motion vector of the current block from the motion vector candidates included in the motion vector candidate list using the motion vector index. The predictor of the encoding apparatus may obtain a motion vector difference (MVD) between the motion vector of the current block and a motion vector predictor, encode the MVD and output the encoded MVD in the form of a bitstream. That is, the MVD may be obtained by subtracting the motion vector predictor from the motion vector of the current block. Here, the predictor (230) may obtain a motion vector included in the information on prediction and derive the motion vector of the current block by adding the motion vector difference to the motion vector predictor. Further, the predictor may obtain or derive a reference picture index indicating a reference picture from the aforementioned information on prediction.

The adder (240) may add a residual sample to a predicted sample to reconstruct a current block or a current picture. The adder (240) may reconstruct the current picture by adding the residual sample to the predicted sample in units of a block. When the skip mode is applied, a residual is not transmitted and thus the predicted sample may become a reconstructed sample. Although the adder (240) is described as a separate component, the adder (240) may be a part of the predictor (230). Meanwhile, the adder (240) may be referred to as a reconstructor or reconstructed block generator.

The filter (250) may apply deblocking filtering, sample adaptive offset and/or ALF to the reconstructed picture. Here, sample adaptive offset may be applied in units of a sample after deblocking filtering. The ALF may be applied after deblocking filtering and/or application of sample adaptive offset.

The memory (260) may store a reconstructed picture (decoded picture) or information necessary for decoding. Here, the reconstructed picture may be the reconstructed picture filtered by the filter (250). For example, the memory (260) may store pictures used for inter-prediction. Here, the pictures used for inter-prediction may be designated according to a reference picture set or a reference picture list. A reconstructed picture may be used as a reference picture for other pictures. The memory (260) may output reconstructed pictures in an output order.

Meanwhile, the intra-prediction mode may include two non-directional intra-prediction modes and 33 directional intra-prediction modes. The non-directional intra-prediction modes may include a planar intra-prediction mode and a DC intra-prediction mode, and the directional intra-prediction modes may include intra-prediction modes #2 to #34. The planar intra-prediction mode may be referred to as a planar mode, and the DC intra-prediction mode may be referred to as a DC mode. The intra-prediction mode #10 may indicate a horizontal intra-prediction mode or a horizontal mode, the intra-prediction mode #26 indicates a vertical intra-prediction mode or a vertical mode, based on which a prediction direction of the directional intra-mode may be expressed by an angle. In other words, a relative angle corresponding to each intra-prediction mode may be expressed with reference to a horizontal reference angle 0° corresponding to the intra-prediction mode #10, and a relative angle corresponding to each intra-prediction mode may be expressed with reference to a vertical reference angle 0° corresponding to the intra-prediction mode #26.

Further, demand for high-quality video is increasing, and in order to increase efficiency of a video codec, the number of directional intra-prediction directions may increase to 65. That is, the intra-prediction mode may include two non-directional intra-prediction modes and 65 directional intra-prediction modes. The non-directional intra-prediction modes may include a planar intra-prediction mode and a DC intra-prediction mode, and the directional intra-prediction modes may include intra-prediction modes #2 to #66.

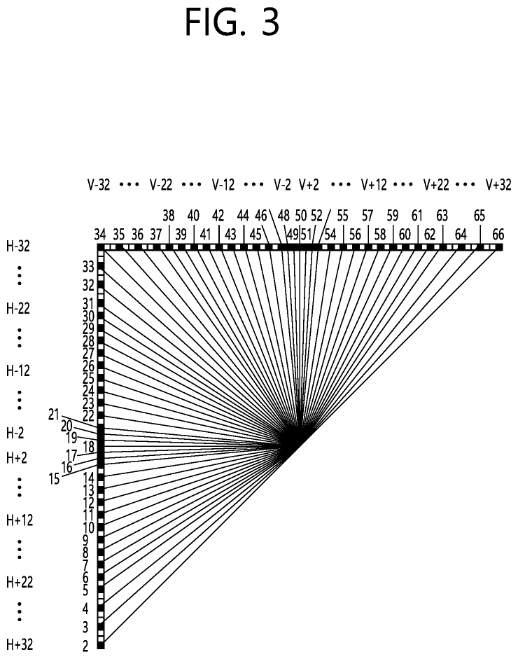

FIG. 3 illustrates intra-directional modes of 65 prediction directions.

Referring to FIG. 3, intra-prediction modes having horizontal directionality and intra-prediction modes having vertical directionality may be classified based on an intra-prediction mode #34 having an upper left diagonal prediction direction. H and V in FIG. 3 represent the horizontal directionality and the vertical directionality, respectively, and the numbers from −32 to 32 represent displacements of 1/32 unit on sample grid positions. The intra-prediction modes #2 to #33 have the horizontal directionality and the intra-prediction modes #34 to #66 have the vertical directionality. The intra-prediction mode #18 and the intra-prediction mode #50 represent a horizontal intra-prediction mode and a vertical intra-prediction mode, respectively, based on which a prediction direction of an angular intra-prediction mode may be expressed by an angle. In other words, a relative angle corresponding to each intra-prediction mode may be expressed based on a horizontal reference angle 0° corresponding to the intra-prediction mode #18, and a relative angle corresponding to each intra-prediction mode may be expressed based on a vertical reference angle 0° corresponding to the intra-prediction mode #50.

If intra prediction is performed as described above, one coding unit may be split into square shaped prediction blocks, and the intra prediction for the prediction block may be performed. Alternatively, the one coding unit may also be split into non-square shaped prediction blocks to improve coding efficiency. A structure in which the one coding unit is split into the square shaped prediction blocks may be referred to as a quad tree (QT) structure, and a structure in which the one coding unit is split into the non-square shaped prediction blocks may be referred to as a quad tree binary tree (QTBT) structure.

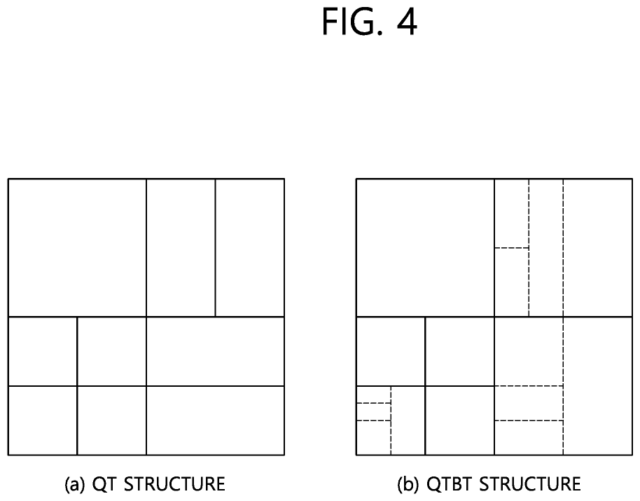

FIG. 4 illustrates an example of a coding unit which is split into a QT structure or a QTBT structure. FIG. 4A may represent a coding block which is split into the square shaped prediction block according to the QT structure. Further, FIG. 4B may represent a coding block which is split into the non-square shaped prediction blocks according to the QTBT structure. The QTBT structure may represent a structure in which the coding block is split based on the QT structure, and the coding block is additionally split in a binary tree (BT) structure based on split flag syntax. That is, the QTBT structure may represent a split structure configured in the form in which the BT structure is combined with the QT structure, the coding block may be split through the QT structure, and a leaf node of the QT structure may be additionally split through the BT structure. A block separated by the solid line in FIG. 4B may represent a square block which is split through the QT structure, and a block separated by the dotted line may represent a non-square block which is split through the BT structure in addition to the QT structure.

Meanwhile, although the conventional method performs intra prediction in units of a prediction unit (PU) having a square shape or a non-square shape, and performs transform in units of a transform unit (TU) having a square shape, the present disclosure may perform a coding process including the prediction and transform based on one processing unit without distinguishing the PU and the TU. The processing unit may be represented as a coding unit (CU). For example, the CU may be split into square blocks and non-square CUs through the QTBT structure, and the intra prediction and transform processes may be performed for each of the CUs. Specifically, the CU may be split through the QT structure, and a leaf node of the QT structure may be additionally split through the BT structure. Here, the leaf node may represent a CU which is no longer split in the QT structure, and the leaf node may also be referred to as a terminal node.

Meanwhile, if the picture of the input image is split through the aforementioned QTBT structure, a luma component and a chroma component of the picture may have different block split structures from each other in order to improve prediction accuracy to enhance coding efficiency.

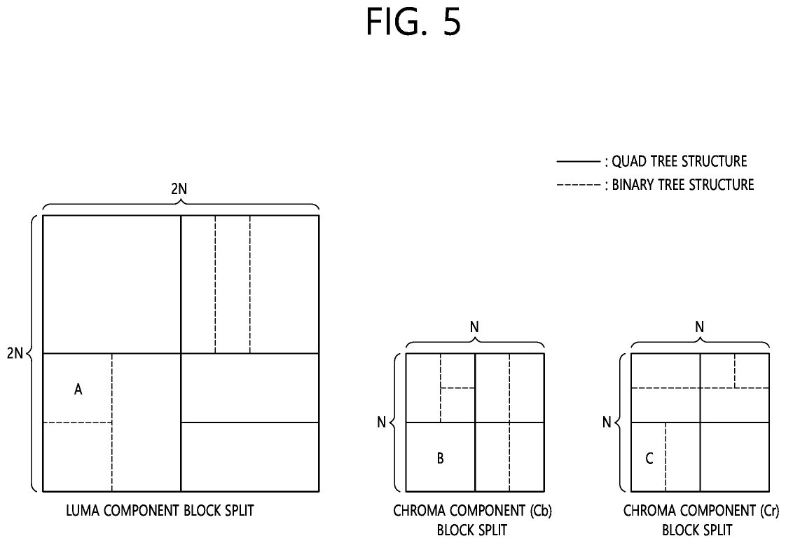

FIG. 5 illustrates an example in which a luma component and a chroma component of a block within a picture are split through different block split structures from each other. Referring to FIG. 5, the input image may include a luma component, a chroma Cb component, and a chroma Cr component. As illustrated in FIG. 5, the luma component, the chroma Cb component, and the chroma Cr component may be split through different block split structures from each other, and thus a block A of the luma component, a block B of the chroma Cb component corresponding to the block A, and a block C of the chroma Cr component may have different block shapes from each other, such that different intra prediction modes may be applied to the block A, the block B, and the block C. Here, the block corresponding to the block may be derived based on the top left position of the block. If the block A, the block B, and the block C have different block shapes from each other and different intra prediction modes from each other are applied thereto, various problems as described later may occur.

First, if the block split structures of the luma component and the chroma component are different, separate transform indexes may be generated for the luma component and the chroma component to require a large amount of bits in order to perform an adaptive multiple core transform (AMT), and thus the transform may be performed only for the luma component based on the adaptive multiple core transform without applying the adaptive multiple core transform to the chroma component. Here, the adaptive multiple core transform may represent a method for performing a transform by additionally using a discrete cosine transform (DCT) type 2, a discrete sine transform (DST) type 7, a DCT type 8, and/or a DST type 1. That is, the AMT may represent a transform method for transforming a residual signal (or residual block) of a spatial domain into modified transform coefficients (or primary transform coefficients) of a frequency domain based on a plurality of transform kernels which are selected from the DCT type 2, the DST type 7, the DCT type 8, and the DST type 1. If the adaptive multiple core transform is performed, a vertical transform kernel and a horizontal transform kernel for a target block among the transform kernels may be selected, and the vertical transform for the target block based on the vertical transform kernel and the horizontal transform for the target block based on the horizontal transform kernel may be performed. Here, the horizontal transform may represent the transform for horizontal components of the target block, and the vertical transform may represent the transform for vertical components of the target block.

Specifically, if an existing transform method is applied, modified transform coefficients (or primary transform coefficients) may be generated by applying the transform from the spatial domain to the frequency domain for the residual signal (or residual block) based on the DCT type 2. Unlike this, if the adaptive multiple core transform is applied, modified transform coefficients (or primary transform coefficients) may be generated by applying the transform from the spatial domain to the frequency domain for the residual signal (or residual block) based on the DCT type 2, the DST type 7, the DCT type 8, and/or the DST type 1. The transform index may indicate a transform type of a block on which transform is performed. Here, the DCT type 2, the DST type 7, the DCT type 8, the DST type 1, and the like may be referred to as transform types, transform kernels, or transform cores.

Accordingly, if the block split structures of the luma component and the chroma component are different, transform types may be different for a block of the luma component and a block of the chroma component corresponding to the block of the luma component, and thus the separate transform indexes for the block of the luma component and the block of the chroma component may be generated and a large amount of bits may be required, such that the transform only for the block of the luma component may be performed based on the adaptive multiple core transform without applying the adaptive multiple core transform to the block of the chroma component.

Second, if the block split structures of the luma component and the chroma component are different, a separate non-separable secondary transform (NSST) index may be generated for the luma component and the chroma component to generate an overbit in order to perform the transform for the luma component and the chroma component based on the NSST. That is, if the luma component and the chroma component have different block split structures from each other, respective residual signals (or residual blocks) for the luma component and the chroma component may have different characteristics from each other, and thus the transform may be performed for the luma component and the chroma component based on different NSST kernels from each other. Accordingly, a secondary transform index indicating the NSST kernel of each of the luma component and the chroma component may be generated, and thus an overbit may be generated. Here, the NSST may represent the transform which performs secondary transform for the primary transform coefficients derived through the DCT type 2 or the AMT based on a non-separable transform matrix to generate transform coefficients (or secondary transform coefficients) for the residual signal. Here, the non-separable transform matrix may represent a matrix which transforms the vertical component and the horizontal component of the primary transform coefficients at once without separating them. That is, the non-separable transform matrix may represent a matrix which performs the vertical transform and the horizontal transform at once. That is, the NSST may represent a transform method which generates transform coefficients (or secondary transform coefficients) by transforming the vertical component and the horizontal component of the primary transform coefficients together without separating based on the non-separable transform matrix. Meanwhile, the size of the non-separable transform matrix may vary according to the size of the target block to be transformed. For example, if the width or height of the target block is 8 or more, the non-separable transform matrix of the 8×8 size may be derived, and if the width or height of the target block is 4, the non-separable transform matrix of the 4×4 size may be derived.

Third, if the block split structures of the luma component and the chroma component are different, there may occur a problem in that it is necessary to determine which one of the luma component and the chroma component the linear interpolation intra prediction is applied or whether to apply linear interpolation intra prediction to both the luma component and the chroma component. That is, if the block split structures of the luma component and the chroma component are different, the luma component and the chroma component have different block shapes from each other or the like, such that it is necessary to determine whether to apply the linear interpolation intra prediction to the luma component and the chroma component. Here, the linear interpolation intra prediction may represent the intra prediction which generates a predicted sample through the interpolation of a first reference sample which is positioned in a prediction direction of an intra prediction mode of a current block and a second reference sample which is positioned in a direction opposite to the prediction direction of the intra prediction mode of the current block based on the predicted sample (or position of the predicted sample) of the current block among neighboring samples including left neighboring samples and top neighboring samples of the current block in which the intra prediction is performed. Further, the linear interpolation intra prediction may also be referred to as linear interpolation prediction.

As described above, if the block split structures of the luma component and the chroma component are different, various problems may occur, such that the present disclosure proposes the solution of the aforementioned problems if the block split structures of the luma component and the chroma component are the same.

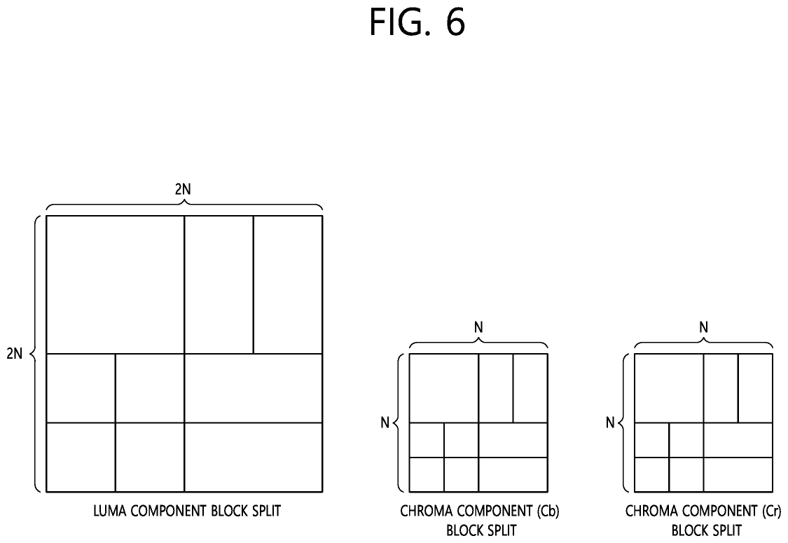

FIG. 6 illustrates an example in which a luma component and a chroma component of a block in a picture are split through the same block split structure. Referring to FIG. 6, the luma component and the chroma component may have the same block split structure, and thus characteristics of the luma component and the chroma component may be very similar. That is, the block of the luma component and the block of the chroma component corresponding to the block of the luma component may have the same shape, and thus the block of the luma component and the block of the chroma component may have similar characteristics. Accordingly, the present disclosure proposes a method for applying the adaptive multiple core transform (AMT) applied to only the luma component in the existing method to the chroma component.

For example, an adaptive multiple core transform index of the luma block corresponding to the current chroma block may be derived, and the adaptive multiple core transform index of the luma block may be used for the AMT of the current chroma block.

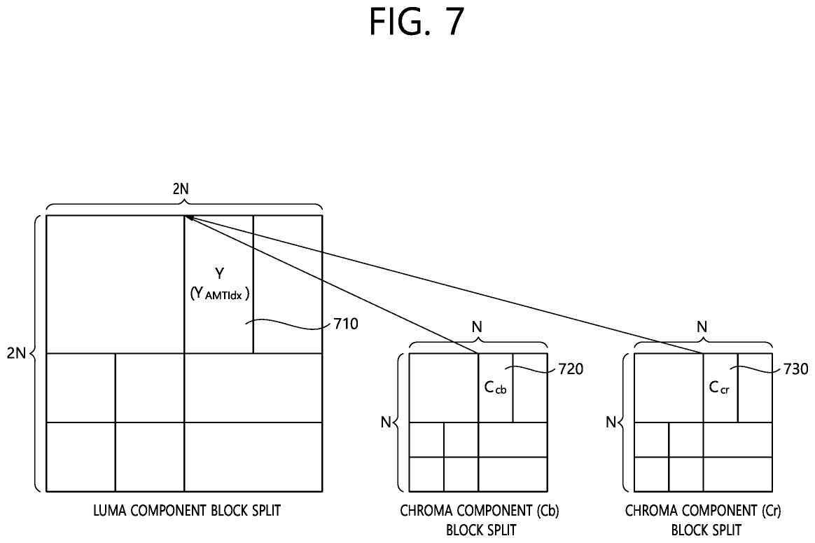

FIG. 7 illustrates an example in which an adaptive multiple core transform is applied to a current chroma block if the luma component and the chroma component have the same block split structure. Referring to FIG. 7, a luma block corresponding to a chroma block to be currently encoded/decoded may be derived, and then if the adaptive multiple core transform is used for the luma block, the adaptive multiple core transform index of the luma block may be derived and applied to the chroma block. Meanwhile, if no adaptive multiple core transform is used for the luma block, the transform performed based on the existing DCT type 2 may be applied to the chroma block.

Specifically, referring to FIG. 7, if a chroma block C_{cb} 720 or a chroma block C_{cr}730 is encoded/decoded, a corresponding luma block Y 710 previously encoded/decoded may be derived at the encoding/decoding time point of the chroma block C_{cb} 720 or the chroma block C_{cr} 730. For example, the corresponding luma block Y 710 may be derived based on the position of the top left sample of the chroma block C_{cb} 720 or the chroma block C_{cr} 730, and specifically, the block of the luma component having the top left sample at a position which corresponds to the position of the top left sample of the chroma block C_{cb} 720 or the chroma block C_{cr} 730 may be derived as the corresponding luma block Y 710.

If the corresponding luma block Y 710 is derived, it is possible to determine whether to apply the adaptive multiple core transform of the chroma block C_{cb} 720 or the chroma block C_{cr} 730 based on an adaptive multiple core transform flag of the corresponding luma block Y 710. Here, the adaptive multiple core transform flag may represent whether to apply the adaptive multiple core transform to the corresponding block. For example, if the value of the adaptive multiple core transform flag of the corresponding luma block Y 710 is 1, the adaptive multiple core transform may be applied to the corresponding luma block Y 710, and if the value of the adaptive multiple core transform flag of the corresponding luma block Y 710 is 0, no adaptive multiple core transform may be applied to the corresponding luma block Y 710.

Accordingly, if the value of the adaptive multiple core transform flag of the corresponding luma block Y 710 is 1, the adaptive multiple core transform is used for the corresponding luma block Y 710, such that the adaptive multiple core transform index used for the corresponding luma block Y 710 may be induced and used to transform the chroma block C_{cb} 720 or the chroma block C_{cr} 730. Here, the syntax element of the adaptive multiple core transform index used for the corresponding luma block Y 710 may be represented as YAMTIdx. Meanwhile, if the value of the adaptive multiple core transform flag of the corresponding luma block Y 710 is 0, no adaptive multiple core transform is used for the corresponding luma block Y 710, such that the transform of the chroma block C_{cb} 720 or the chroma block C_{cr} 730 may be performed based on the DCT type 2 which is the existing basic transform kernel.

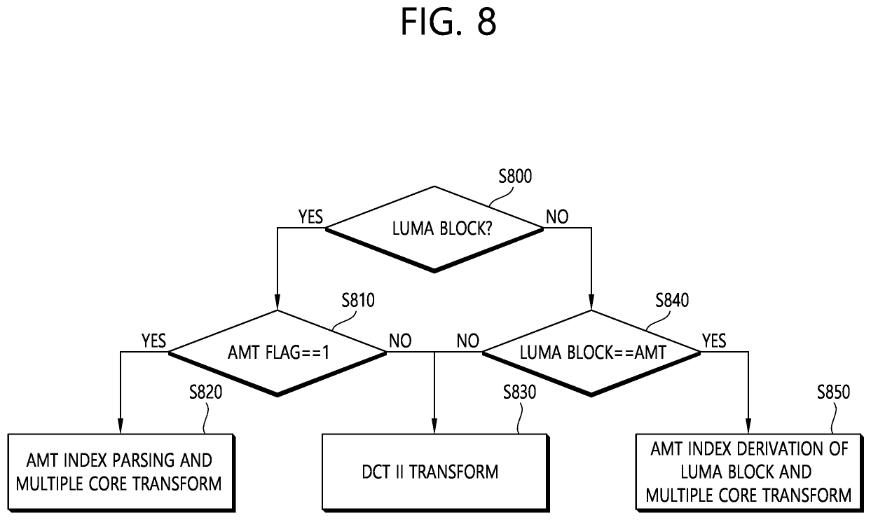

FIG. 8 illustrates an example in which the adaptive multiple core transform is applied to a current block to be currently encoded. Referring to FIG. 8, it may be determined whether the current block is a luma block (S800). If the current block is the luma block, it may be determined whether to apply the adaptive multiple core transform to the current block based on an adaptive multiple core transform flag (AMT flag) for the current block. Accordingly, if the current block is the luma block, it may be determined whether the value of the AMT flag of the current block is 1 (S810). If the value of the AMT flag of the current block is 1, an adaptive multiple core transform index (AMT index) of the current block may be parsed, and the adaptive multiple core transform for the current block may be performed based on the AMT index (S820). Further, if the value of the AMT flag of the current block is not 1, the transform of the current block may be performed based on the DCT type 2 (S830).

Meanwhile, the current block may also be a chroma block rather than the luma block. That is, if the current block is not the luma block, it may be determined whether to apply the adaptive multiple core transform to a corresponding luma block corresponding to the current block (S840). Whether to apply the adaptive multiple core transform to the corresponding luma block may be determined based on the AMT flag of the corresponding luma block. For example, if the value of the AMT flag of the corresponding luma block is 1, the adaptive multiple core transform may be applied to the corresponding luma block, and if the value of the AMT flag of the corresponding luma block is 0, no adaptive multiple core transform may be applied to the corresponding luma block.

If no adaptive multiple core transform is applied to the corresponding luma block, the transform of the current block may be performed based on the DCT type 2 (S830). Further, if the adaptive multiple core transform is applied to the corresponding luma block, the AMT index of the corresponding luma block of the current block may be derived, and the adaptive multiple core transform for the current block may be performed based on the AMT index (S850).

Meanwhile, if the luma component and the chroma component have the same block split structure as described above, the block of the luma component and the block of the chroma component corresponding to the block of the luma component may have the same shape, and thus the block of the luma component and the block of the chroma component may have similar characteristics. Accordingly, the present disclosure proposes a method for more effectively applying the non-separable secondary transform (NSST) applied to the luma component and the chroma component, respectively, in the existing method to the chroma component.

If the luma component and the chroma component have the same block split structure, the characteristics of the luma component and the chroma component may be very similar, and thus by applying the non-separable secondary transform to the chroma component through the following method, it is possible to further improve coding efficiency.

As an example, information about the non-separable secondary transform of the corresponding luma block corresponding to the chroma block may be derived and used for transforming the chroma block. For example, if the chroma block C_{c}b 720 or the chroma block C_{cr} 730 illustrated in FIG. 7 described above is encoded/decoded, the corresponding luma block Y 710 previously encoded/decoded may be derived at the encoding/decoding time point of the chroma block C_{cb} 720 or the chroma block C_{cr} 730. If the corresponding luma block Y 710 is derived, the non-separable secondary transform applied to the corresponding luma block Y 710 may be applied to the chroma block C_{cb} 720 or the chroma block C_{cr} 730 as it is. That is, the non-separable secondary transform of the chroma block C_{cb} 720 or the chroma block C_{cr} 730 may be performed based on the non-separable transform matrix of the corresponding luma block Y 710. In this case, the non-separable secondary transform index (NSST index) indicating the non-separable transform matrix of the corresponding luma block Y 710 may be derived, and the non-separable secondary transform index may be used for the non-separable secondary transform of the chroma block C_{c}b 720 or the chroma block C_{cr} 730. That is, the NSST index of the corresponding luma block Y 710 may be derived, and the non-separable secondary block of the chroma block C_{cb} 720 or the chroma block C_{cr} 730 may be performed based on the non-separable transform matrix indicated by the NSST index. Accordingly, it is not necessary to transmit the NSST index signaled to perform the non-separable secondary transform of the chroma block C_{cb} 720 or the chroma block C_{cr} 730 transmitted in the existing method, and as a result, it is possible to reduce the amount of bits for the non-separable secondary transform of the chroma block C_{cb} 720 or the chroma block C_{cr} 730 and to improve the overall coding efficiency.

Further, a flag representing whether the same non-separable secondary transform as the non-separable secondary transform of the corresponding luma block is performed for the chroma block may be transmitted, and whether to apply the non-separable secondary transform to the corresponding luma block may be determined based on the flag. For example, if the chroma block C_{cb} 720 or the chroma block C_{cr} 730 illustrated in FIG. 7 described above is encoded/decoded, a flag representing whether the same non-separable secondary transform as the non-separable secondary transform of the corresponding luma block Y 710 is applied to the chroma block C_{cb} 720 or the chroma block C_{cr} 730 may be received, and it may be determined whether the same non-separable secondary transform as the non-separable secondary transform of the corresponding luma block Y 710 is applied to the chroma block C_{c}b 720 or the chroma block C_{cr} 730 based on the flag.

If the same non-separable secondary transform as the non-separable secondary transform of the corresponding luma block Y 710 is applied to the chroma block C_{cb} 720 or the chroma block C_{cr} 730, a value of the flag is 1 and the flag may be encoded/decoded, and no separate NSST index for performing non-separable secondary transform of the chroma block C_{cb} 720 or the chroma block C_{cr} 730 may be transmitted. In this case, the NSST index of the corresponding luma block Y 710 may be derived, and the non-separable secondary transform of the chroma block C_{cb} 720 or the chroma block C_{cr} 730 may be performed based on the non-separable transform matrix indicated by the NSST index.

Further, if the same non-separable secondary transform as the non-separable secondary transform of the corresponding luma block Y 710 is not applied to the chroma block C_{cb} 720 or the chroma block C_{cr} 730 illustrated in FIG. 7 described above, a value of the flag is 0 and the flag may be encoded/decoded, and the NSST index of the chroma block C_{cb} 720 or the chroma block C_{cr} 730 may be additionally transmitted. In this case, the non-separable secondary transform of the chroma block C_{cb} 720 or the chroma block C_{cr} 730 may be performed based on the non-separable transform matrix indicated by the NSST index of the chroma block C_{cb} 720 or the chroma block C_{cr} 730.

Meanwhile, if the luma component and the chroma component have the same block split structure as described above, the block of the luma component and the block of the chroma component corresponding to the block of the luma component may have the same shape, and thus the block of the luma component and the block of the chroma component may have similar characteristics. Accordingly, the present disclosure proposes a method for performing block linear interpolation prediction for the chroma component more efficiently, if the luma component and the chroma component have the same block split structure considering that the block of the luma component and the block of the chroma component have similar characteristics. The linear interpolation prediction may also be referred to as linear interpolation intra prediction.

As an example, the linear interpolation intra prediction may be performed only for the luma component. That is, whether to apply the linear interpolation intra prediction to the luma component may be determined in view of rate distortion optimization (RDO). Accordingly, whether to apply the linear interpolation intra prediction to the luma component and an optimal intra prediction mode may be selected. Accordingly, in this case, a linear interpolation prediction flag indicating whether to apply the linear interpolation prediction may be encoded/decoded only for the luma component, and the linear interpolation prediction may be applied only to the luma component based on the linear interpolation prediction flag.

As another example, the linear interpolation prediction may be independently applied to the luma component and the chroma component. In view of the rate distortion optimization, whether to apply the linear interpolation intra prediction to each of the luma component and the chroma component may be determined. In this case, a total of 4 rate distortion costs may be calculated for one intra prediction mode. That is, if the existing intra prediction is performed for the luma component and the chroma component based on the intra prediction mode, the existing intra prediction for the luma component is performed based on the intra prediction mode, and if the linear interpolation intra prediction is performed for the chroma component, the linear interpolation intra prediction is performed for the luma component based on the intra prediction mode, and if the existing intra prediction for the chroma component is performed, and if the linear interpolation intra prediction is performed for the luma component and the chroma component based on the intra prediction mode, each rate distortion cost may be calculated. In this case, the linear interpolation prediction flag representing whether to apply the linear interpolation prediction may be encoded/decoded for each of the luma component and the chroma component, and the linear interpolation prediction for the luma component and the chroma component may be independently determined based on the linear interpolation prediction flag for each of the luma component and the chroma component. The method for independently determining whether to apply the linear interpolation prediction to the luma component and the chroma component may have a higher complexity than the aforementioned method in which the linear interpolation prediction is applied only to the luma component, but more cases are compared and an optimal mode may be selected, and as a result, higher encoding/decoding efficiency may be derived.

As another example, whether to apply the linear interpolation prediction to the chroma component may be determined based on whether to apply the linear interpolation intra prediction to the luma component. Specifically, for example, it may be determined whether to apply the linear interpolation intra prediction to the corresponding block which is a block of the luma component in view of the rate distortion optimization, and whether to apply the linear interpolation intra prediction to the current block which is the block of the chroma component may be determined based on whether to apply the linear interpolation intra prediction to the corresponding block. That is, if the linear interpolation intra prediction is applied to the corresponding block, the linear interpolation intra prediction may also be applied to the current block, and if no linear interpolation intra prediction is applied to the corresponding block, no linear interpolation intra prediction may be applied to the current block either. Whether to apply the linear interpolation intra prediction to the corresponding block may be determined based on the linear interpolation prediction flag of the corresponding block. Here, the corresponding block may represent the luma block corresponding to the current block.

In this case, only the linear interpolation prediction flag representing whether to apply the linear interpolation intra prediction to the corresponding block may be encoded/decoded, and whether to apply the linear interpolation intra prediction to the current block may be determined based on the linear interpolation prediction flag of the corresponding block.

In the aforementioned method for applying the linear interpolation prediction to the chroma component based on whether to apply the linear interpolation intra prediction to the luma component, as in the method for applying the linear interpolation intra prediction only to the luma component, only the linear interpolation prediction flag of the luma component may be encoded/decoded, but whether to apply the linear interpolation prediction to the chroma component may also be determined based on the linear interpolation prediction flag of the luma component, such that the method for applying the linear interpolation prediction to the chroma component based on whether to apply the linear interpolation intra prediction to the luma component may be an intermediate method between the method for applying the linear interpolation intra prediction only to the luma component and the method for independently determining whether to apply the linear interpolation prediction to the luma component and the chroma component, which are described above.

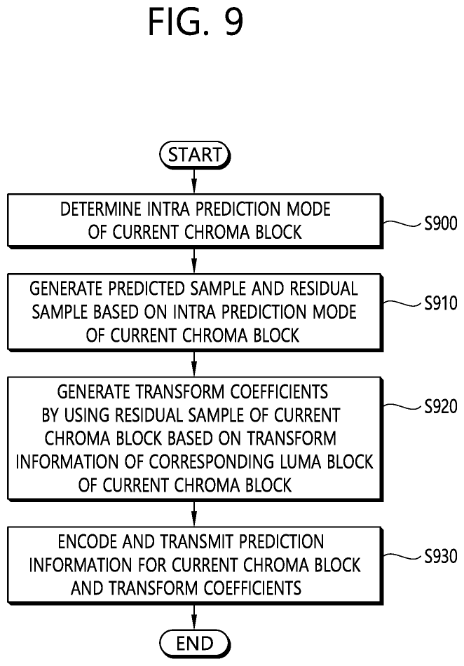

FIG. 9 schematically illustrates a video encoding method by an encoding apparatus according to the present disclosure. The method illustrated in FIG. 9 may be performed by the encoding apparatus illustrated in FIG. 1. Specifically, for example, S900 and S910 illustrated in FIG. 9 may be performed by the predictor of the encoding apparatus, S920 may be performed by the transformer of the encoding apparatus, and S930 may be performed by the entropy encoder of the encoding apparatus.

The encoding apparatus determines an intra prediction mode for the current chroma block (S900). The encoding apparatus may perform various intra prediction modes to derive an intra prediction mode having an optimal RD cost as an intra prediction mode for the current chroma block. The intra prediction mode may be one of two non-directional prediction modes and 33 directional prediction modes. As described above, the two non-directional prediction modes may include an intra DC mode and an intra planar mode. Alternatively, the intra prediction mode may be one of two non-directional intra prediction modes and 65 directional intra prediction modes. As described above, the two non-directional prediction modes may include an intra DC mode and an intra planar mode. Further, the 65 directional intra prediction modes may include vertical directional intra prediction modes and horizontal directional intra prediction modes. The vertical directional intra prediction modes may include a 34th intra prediction mode to a 66th intra prediction mode, and the horizontal directional intra prediction modes may include a 2nd intra prediction mode to a 33th intra prediction mode.

Meanwhile, the encoding apparatus may determine whether to perform linear interpolation prediction for the current chroma block. For example, whether to perform the linear interpolation prediction for the current chroma block may be determined independently of whether to perform the linear interpolation prediction for the corresponding luma block of the current chroma block. In this case, the encoding apparatus may compare the RD costs in the case of performing the linear interpolation prediction and in the case of performing the existing intra prediction, and if the RD cost in the case of performing the linear interpolation prediction is an optimal RD cost, it may be determined that the linear interpolation prediction is performed for the current chroma block. Further, as another example, the encoding apparatus may determine whether to perform the linear interpolation prediction for the current chroma block based on whether to perform the linear interpolation prediction for the corresponding luma block. In this case, if the linear interpolation prediction is performed for the corresponding luma block, it may be determined that the linear interpolation prediction is also performed for the current chroma block, and if no linear interpolation prediction is performed for the corresponding luma block, it may be determined that no linear interpolation prediction is performed for the current chroma block. A linear interpolation prediction flag of the corresponding luma block representing whether to perform the linear interpolation prediction for the corresponding luma block may be generated. If a value of the linear interpolation prediction flag is 1, the linear interpolation prediction flag may represent that the linear interpolation intra prediction is performed for the corresponding luma block, and if the value of the linear interpolation prediction flag is 0, the linear interpolation prediction flag may represent that no linear interpolation intra prediction is performed for the corresponding luma block. Here, the corresponding luma block may represent the block of the luma component corresponding to the current chroma block. The corresponding luma block may be derived based on the position of the top left sample of the chroma block. Specifically, the block of the luma component having the top left sample at a position corresponding to the position of the top left sample of the chroma block may be derived as the corresponding luma block.

The encoding apparatus generates a predicted sample and a residual sample based on the intra prediction mode of the current chroma block (S910). The encoding apparatus may derive neighboring samples of the current chroma block. The neighboring samples may include left neighboring samples, top left neighboring samples, and top neighboring samples. The left neighboring samples, the top left neighboring sample, and the top neighboring samples may be derived from neighboring blocks already reconstructed at a decoding time point of the current chroma block. Here, if the size of the current chroma block is N×N, the x component of the top left sample of the current chroma block is 0, and the y component thereof is 0, the left neighboring samples may be p [−1] [0] to p [−1] [N−1], the top left neighboring sample may be p [−1] [−1], and the top neighboring samples may be p [0] [−1] top [N−1] [−1].

The encoding apparatus may derive a reference sample which is positioned in a prediction direction of the intra prediction mode based on the predicted sample (or the location of the predicted sample) among the neighboring samples. The encoding apparatus may generate the predicted sample of the target sample based on the reference sample. The encoding apparatus may derive the sample value of the predicted sample by copying the sample value of the target sample.

Meanwhile, if it is determined that the linear interpolation intra prediction is performed for the current chroma block, the encoding apparatus may perform the linear interpolation prediction to generate the predicted sample of the current chroma block. Specifically, the encoding apparatus may derive a first reference sample which is positioned in a prediction direction of the intra prediction mode and a second reference sample which is positioned in a direction opposite to the prediction direction based on the predicted sample of the current chroma block, and generate the predicted sample based on the interpolation (or linear interpolation) of the first reference sample and the second reference sample.

The encoding apparatus may generate a residual sample based on the predicted sample. The encoding apparatus may generate the residual sample based on a comparison between the original chroma block of the original picture for the current picture and the current chroma block. In this case, a difference between the original sample and the predicted sample may be the residual sample.

The encoding apparatus generates transform coefficients by using the residual sample of the current chroma block based on the transform information of the corresponding luma block of the current chroma block (S920). The encoding apparatus may perform the transform of the current chroma block based on the transform information of the corresponding luma block. Meanwhile, if the block split structures of the current chroma block and the corresponding luma block are the same, the residual sample of the current chroma block is transformed based on the transform information of the corresponding luma block of the current chroma block, and thus the transform coefficients of the current chroma block may also be generated. For example, the encoding apparatus may generate modified transform coefficients (or primary transform coefficients) by transforming the residual sample based on the discrete cosine transform (DCT) type 2, and generate transform coefficients (or secondary transform coefficients) of the current chroma block by performing the non-separable secondary transform (NSST) for the modified transform coefficients (or primary transform coefficients). Alternatively, the encoding apparatus may generate the modified transform coefficients (or primary transform coefficients) by performing the adaptive multiple core transform (AMT) for the residual sample, and generate the transform coefficients (or secondary transform coefficients) of the current chroma block by performing the non-separable secondary transform (NSST) for the modified transform coefficients (or primary transform coefficients).

Specifically, for example, if the adaptive multiple core transform is performed for the corresponding luma block, the encoding apparatus performs the adaptive multiple core transform for the current chroma block based on the adaptive multiple core transform information of the corresponding luma block. The adaptive multiple core transform may represent the transform performed based on a plurality of transform kernels for the corresponding block (for example, the corresponding luma block or the current chroma block). For example, the encoding apparatus may derive the plurality of transform kernels for the current chroma block based on the adaptive multiple core transform index of the corresponding luma block, and generate the modified transform coefficients (or primary transform coefficients) by transforming the residual sample based on the plurality of transform kernels. Here, the plurality of transform kernels may be transform kernels indicated by the adaptive multiple core transform index among the discrete cosine transform (DCT) Type 2, the DCT Type 8, the discrete sine transform (DST) Type 1, and the DST Type 7.

Meanwhile, the encoding apparatus may determine whether to perform the adaptive multiple core transform for the current chroma block based on whether to perform the adaptive multiple core transform for the corresponding luma block, that is, whether to generate the modified transform coefficients (or primary transform coefficients) by transforming the residual sample based on the plurality of transform kernels. For example, if the adaptive multiple core transform is performed for the corresponding luma block, the plurality of transform kernels for the current chroma block may be derived based on the adaptive multiple core transform index of the corresponding luma block, and the residual sample of the current chroma block may be transformed based on the plurality of transform kernels to generate the modified transform coefficients (or primary transform coefficients). Further, if no adaptive multiple core transform is performed for the corresponding luma block, the residual sample of the current chroma block may be transformed based on the DCT type 2 to generate the modified transform coefficients (or primary transform coefficients). An adaptive multiple core transform flag of the corresponding luma block representing whether the residual sample of the corresponding luma block is transformed based on the plurality of transform kernels may be generated.

Meanwhile, if the modified transform coefficients are generated, the non-separable secondary transform (NSST) may be performed for the modified transform coefficients to generate transform coefficients of the current chroma block.

For example, if the non-separable secondary transform is performed for the corresponding luma block, the encoding apparatus may perform the non-separable secondary transform for the current chroma block based on the non-separable secondary transform information of the corresponding luma block. That is, the encoding apparatus may generate transform coefficients of the current chroma block by performing the non-separable secondary transform for the modified transform coefficients of the current chroma block based on the non-separable secondary transform information of the corresponding luma block. Here, the non-separable secondary transform may represent a transform which generates the transform coefficients (or secondary transform coefficients) by performing the secondary transform for the modified transform coefficients (or primary transform coefficients) based on the non-separable transform matrix. Here, the non-separable transform matrix may represent a matrix which transforms the vertical components and the horizontal components of the primary transform coefficients at once without separating them. That is, the non-separable transform matrix may represent a matrix which performs the vertical transform and the horizontal transform at once. That is, the NSST may represent a transform method which generates the transform coefficients (or secondary transform coefficients) by transforming the vertical components and the horizontal components of the primary transform coefficients together without separating them based on the non-separable transform matrix.

Specifically, the encoding apparatus may derive a non-separable secondary transform (NSST) index of the corresponding luma block, and generate the transform coefficients (or secondary transform coefficients) of the current chroma block by transforming the modified transform coefficients (or primary transform coefficients) based on the non-separable transform matrix indicated by the non-separable secondary transform index.

Meanwhile, the encoding apparatus may generate a flag representing whether to use the non-separable secondary transform index of the corresponding luma block. For example, if a value of the flag is 1, the flag may represent that the non-separable secondary transform index of the corresponding luma block is used, and if the value of the flag is 0, the flag may represent that no non-separable secondary transform index of the corresponding luma block is used.

The encoding apparatus encodes and transmits prediction information and the transform coefficients for the current chroma block (S930). The encoding apparatus may encode the prediction information about the current chroma block to output the encoded prediction information in the form of a bitstream. The prediction information may include information about the intra prediction mode of the current chroma block. The encoding apparatus may generate information about the intra prediction mode representing the intra prediction mode, and encode and output the information in the form of a bitstream. The information about the intra prediction mode may also include information directly representing the intra prediction mode for the current chroma block, or may also include information representing any one candidate of an intra prediction mode candidate list derived based on the intra prediction mode of the left or top block of the current chroma block.

Further, the prediction information may include a flag representing whether to use the non-separable secondary transform index of the corresponding luma block of the current chroma block. When the flag represents that the non-separable secondary transform index of the corresponding luma block is used, the non-separable secondary transform index of the corresponding luma block may be derived, and when the flag represents that no non-separable secondary transform index of the corresponding luma block is used, the prediction information may include the non-separable secondary transform index of the current chroma block. The non-separable secondary transform index of the current chroma block may represent the non-separable transform matrix for non-separable secondary transform of the current chroma block. If the value of the flag is 1, the flag may represent that the non-separable secondary transform index of the corresponding luma block is used, and if the value of the flag is 0, the flag may represent that no non-separable secondary transform index of the corresponding luma block is used.

Further, the prediction information may include a linear interpolation prediction flag representing whether to perform the linear interpolation prediction for the current chroma block. If the linear interpolation prediction flag represents that the linear interpolation prediction is performed for the current chroma block, the linear interpolation prediction may be performed for the current chroma block, and if the linear interpolation prediction flag represents that no linear interpolation prediction is performed for the current chroma block, no linear interpolation prediction may be performed for the current chroma block. If a value of the linear interpolation prediction flag is 1, the linear interpolation prediction flag may represent that the linear interpolation prediction is performed for the current chroma block, and if the value of the linear interpolation prediction flag is 0, the linear interpolation prediction flag may represent that no linear interpolation prediction is performed for the current chroma block. The syntax element for the linear interpolation prediction flag may be represented as LIP_FLAG.

Meanwhile, the prediction information and the transform information about the corresponding luma block of the current chroma block may be transmitted. For example, the transform information may include the adaptive multiple core transform index of the corresponding luma block. The adaptive multiple core transform index may represent the transform kernels used for the adaptive multiple core transform of the corresponding luma block among the discrete cosine transform (DCT) type 2, the DCT type 8, the discrete sine transform (DST) type 1, and the DST type 7.

Further, the transform information may include the adaptive multiple core transform flag of the corresponding luma block. The adaptive multiple core transform flag may represent whether to perform the adaptive multiple core transform for the corresponding luma block. That is, the adaptive multiple core transform flag may represent whether the residual sample of the corresponding luma block is transformed based on the plurality of transform kernels. If the value of the adaptive multiple core transform flag is 1, the adaptive multiple core transform flag may represent that the residual sample of the corresponding luma block is transformed based on the plurality of transform kernels, and if the value of the adaptive multiple core transform flag is 0, the adaptive multiple core transform flag may represent that no residual sample of the corresponding luma block is transformed based on the plurality of transform kernels.

Further, the transform information may include the non-separable secondary transform (NSST) index of the corresponding luma block. The non-separable secondary transform index of the corresponding luma block may represent the non-separable transform matrix used for the non-separable secondary transform.

Further, the prediction information may include a linear interpolation prediction flag representing whether to perform the linear interpolation prediction for the corresponding luma block. If the linear interpolation prediction flag represents that the linear interpolation prediction is performed for the corresponding luma block, the linear interpolation prediction may be performed for the corresponding luma block, and if the linear interpolation prediction flag represents that no linear interpolation prediction is performed for the corresponding luma block, no linear interpolation prediction may be performed for the corresponding luma block. If the value of the linear interpolation prediction flag is 1, the linear interpolation prediction flag may represent that the linear interpolation prediction is performed for the corresponding luma block, and if the value of the linear interpolation prediction flag is 0, the linear interpolation prediction flag may represent that no linear interpolation prediction is performed for the corresponding luma block. The syntax element for the linear interpolation prediction flag may be represented as LIP_FLAG.

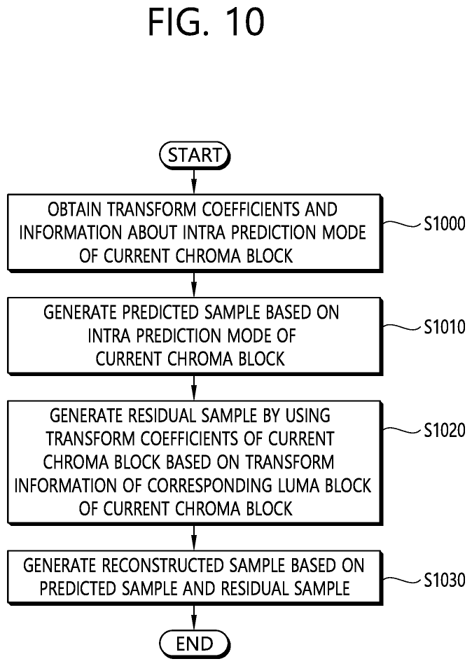

FIG. 10 schematically illustrates a video decoding method by a decoding apparatus according to the present disclosure. The method illustrated in FIG. 10 may be performed by the decoding apparatus illustrated in FIG. 2. Specifically, for example, S1000 illustrated in FIG. 10 may be performed by the entropy decoder of the decoding apparatus, and S1010 and S1020 may be performed by the predictor of the decoding apparatus, and S1030 may be performed by the predictor of the decoding apparatus.

The decoding apparatus obtains transform coefficients and information about the intra prediction mode of the current chroma block (S1000). The decoding apparatus may obtain the information about the intra prediction mode and the transform coefficients through entropy decoding.

The decoding apparatus may obtain prediction information about the current chroma block through a bitstream. The prediction information may also include information directly representing the intra prediction mode for the current chroma block, or may also include information representing any one candidate of the intra prediction mode candidate list derived based on the intra prediction mode of the left or upper block of the current chroma block. The decoding apparatus may derive the intra prediction mode for the current chroma block based on the obtained prediction information. The intra prediction mode may be one of two non-directional prediction modes and 33 directional prediction modes. As described above, the two non-directional prediction modes may include an intra DC mode and an intra planar mode. Alternatively, the intra prediction mode may be one of two non-directional intra prediction modes and 65 directional intra prediction modes. As described above, the two non-directional prediction modes may include an intra DC mode and an intra planar mode. Further, the 65 directional intra prediction modes may include vertical directional intra prediction modes and horizontal directional intra prediction modes. The vertical directional intra prediction modes may include a 34th intra prediction mode to a 66th intra prediction mode, and the horizontal directional intra prediction modes may include a 2nd intra prediction mode to a 33th intra prediction mode.

Meanwhile, the prediction information may include a linear interpolation prediction flag representing whether to perform the linear interpolation prediction for the current chroma block. Whether to perform the linear interpolation prediction for the current chroma block may be determined based on the linear interpolation prediction flag. That is, whether to perform the linear interpolation prediction for the current chroma block may be derived based on the linear interpolation prediction flag. If the linear interpolation prediction flag represents that the linear interpolation prediction is performed for the current chroma block, the linear interpolation prediction may be performed for the current chroma block, and if the linear interpolation prediction flag represents that no linear interpolation prediction is performed for the current chroma block, no linear interpolation prediction may be performed for the current chroma block. If the value of the linear interpolation prediction flag is 1, the linear interpolation prediction flag may represent that the linear interpolation prediction is performed for the current chroma block, and if the value of the linear interpolation prediction flag is 0, the linear interpolation prediction flag may represent that no linear interpolation prediction is performed for the current chroma block. The syntax element for the linear interpolation prediction flag may be represented as LIP_FLAG.

Further, a flag representing whether to use the non-separable secondary transform index of the corresponding luma block may be obtained through the bitstream. When the flag represents that the non-separable secondary transform index of the corresponding luma block is used, the non-separable secondary transform index of the corresponding luma block may be derived, and when the flag represents that no non-separable secondary transform index of the corresponding luma block is used, the non-separable secondary transform index of the current chroma block may be obtained through the bitstream. The non-separable secondary transform index of the current chroma block may represent the non-separable transform matrix for the non-separable secondary transform of the current chroma block. If the value of the flag is 1, the flag may represent that the non-separable secondary transform index of the corresponding luma block is used, and if the value of the flag is 0, the flag may represent that no non-separable secondary transform index of the corresponding luma block is used. In this case, the non-separable secondary transform index of the current chroma block may be obtained through the bitstream.

The decoding apparatus generates a predicted sample based on the intra prediction mode of the current chroma block (S1010). The decoding apparatus may derive neighboring samples of the current chroma block. The neighboring samples may include left neighboring samples, top left neighboring samples, and top neighboring samples. The left neighboring samples, the top left neighboring sample, and the top neighboring samples may be derived from the neighboring blocks already reconstructed at a decoding time point of the current chroma block. Here, if the size of the current chroma block is N×N, the x component of the top left sample of the current chroma block is 0, and the y component thereof is 0, the left neighboring samples may be p [−1] [0] to p [−1] [N−1], the top left neighboring sample may be p [−1] [−1], and the top neighboring samples may be p [0][−1] top [N−1] [−1].

The decoding apparatus may derive a reference sample which is positioned in a prediction direction of the intra prediction mode based on the predicted sample (or the position of the predicted sample) among the neighboring samples. The decoding apparatus may generate the predicted sample of the target sample based on the reference sample. The decoding apparatus may derive a sample value of the predicted sample by copying a sample value of the target sample.

Meanwhile, the decoding apparatus may determine whether to perform the linear interpolation prediction for the current chroma block. For example, whether to perform the linear interpolation prediction for the current chroma block may be determined based on the linear interpolation prediction flag of the current chroma block. If the linear interpolation prediction flag represents that the linear interpolation prediction is performed for the current chroma block, the linear interpolation prediction may be performed for the current chroma block, and if the linear interpolation prediction flag represents that no linear interpolation prediction is performed for the current chroma block, no linear interpolation prediction may be performed for the current chroma block.

Further, as another example, the decoding apparatus may determine whether to perform the linear interpolation prediction for the current chroma block based on whether to perform the linear interpolation prediction for the corresponding luma block. In this case, if the linear interpolation prediction is performed for the corresponding luma block, it may be determined that the linear interpolation prediction is also performed for the current chroma block, and if no linear interpolation prediction is performed for the corresponding luma block, it may be determined that no linear interpolation prediction is performed for the current chroma block either. For example, the linear interpolation prediction flag of the corresponding luma block representing whether to perform the linear interpolation prediction for the corresponding luma block may be derived, and whether to perform the linear interpolation prediction for the current chroma block may be determined based on the linear interpolation prediction flag of the corresponding luma block. The linear interpolation prediction flag may represent whether to perform the linear interpolation prediction for the corresponding luma block. If the value of the linear interpolation prediction flag of the corresponding luma block is 1, the linear interpolation prediction may be performed for the current chroma block, and if the value of the linear interpolation prediction flag of the corresponding luma block is 0, no linear interpolation prediction may be performed for the current chroma block. Here, the corresponding luma block may represent the block of the luma component corresponding to the current chroma block. The corresponding luma block may be derived based on the position of the top left sample of the chroma block. Specifically, the block of the luma component having the top left sample at a position corresponding to the position of the top left sample of the chroma block may be derived as the corresponding luma block.

Meanwhile, if it is determined that the linear interpolation intra prediction is performed for the current chroma block, the decoding apparatus may generate the predicted sample of the current chroma block by performing the linear interpolation prediction. Specifically, the decoding apparatus may derive a first reference sample which is positioned in a prediction direction of the intra prediction mode and a second reference sample which is positioned in a direction opposite to the prediction direction based on the predicted sample of the current chroma block, and generate the predicted sample based on the interpolation (or linear interpolation) of the first reference sample and the second reference sample.

The decoding apparatus generates a residual sample by using the transform coefficients of the current chroma block based on the transform information of the corresponding luma block of the current chroma block (S1020). The decoding apparatus may perform inverse transform of the current chroma block based on the transform information of the corresponding luma block. For example, the decoding apparatus may generate modified transform coefficients (or primary transform coefficients) of the current chroma block by inverse-transforming the transform coefficients based on the non-separable secondary transform information of the corresponding luma block, and generate the residual sample of the current chroma block by inverse-transforming the modified transform coefficients (or primary transform coefficients) based on the discrete cosine transform (DCT) type 2. Alternatively, the decoding apparatus may generate the modified transform coefficients (or primary transform coefficients) of the current chroma block by inverse-transforming the transform coefficients based on the non-separable secondary transform information of the corresponding luma block, and generate the residual sample of the current chroma block by inverse-transforming the modified transform coefficients based on the adaptive multiple core transform (AMT) information of the corresponding luma block. Meanwhile, if the block split structures of the current chroma block and the corresponding luma block are the same, the residual sample of the current chroma block may be inversely transformed based on the transform information of the corresponding luma block of the current chroma block to also generate the transform coefficients of the current chroma block.

Specifically, if the non-separable secondary transform (NSST) is performed for the corresponding luma block, the decoding apparatus may perform non-separable secondary inverse transform for the current chroma block based on the non-separable secondary transform information of the corresponding luma block. The non-separable secondary inverse transform may represent an inverse transform which generates the modified transform coefficients (or primary transform coefficients) by inverse-transforming the transform coefficients (or secondary transform coefficients) based on the non-separable transform matrix. Here, the non-separable transform matrix may represent a matrix which transforms the vertical components and the horizontal components of the primary transform coefficients at once without separating them. That is, the non-separable transform matrix may represent a matrix which performs vertical transform and horizontal transform at once. That is, the non-separable secondary inverse transform may represent an inverse transform which generates the modified transform coefficients (or primary transform coefficients) by inverse-transforming the vertical components and the horizontal components of the transform coefficients (or secondary transform coefficients) together without separating them based on the non-separable transform matrix.

For example, the decoding apparatus may derive a non-separable secondary transform (NSST) index of the corresponding luma block, and generate the modified transform coefficients (or primary transform coefficients) by inverse-transforming the transform coefficients (or secondary transform coefficients) of the current chroma block based on the non-separable transform matrix indicated by the non-separable secondary transform index.

Meanwhile, a flag representing whether to use the non-separable secondary transform index of the corresponding luma block may be obtained through the bitstream. For example, when the flag represents that the non-separable secondary transform index of the corresponding luma block is used, the non-separable secondary transform index of the corresponding luma block may be derived, and when the flag represents that no non-separable secondary transform index of the corresponding luma block is used, the non-separable secondary transform index of the current chroma block may be obtained through the bitstream. If the value of the flag is 1, the flag may represent that the non-separable secondary transform index of the corresponding luma block is used, and if the value of the flag is 0, the flag may represent that no non-separable secondary transform index of the corresponding luma block is used.

Meanwhile, if the modified transform coefficients are generated, the residual sample of the current chroma block may be generated by inverse-transforming the modified transform coefficients (or primary transform coefficients) based on the adaptive multiple core transform (AMT) information of the corresponding luma block.

For example, if the adaptive multiple core transform is performed for the corresponding luma block, the decoding apparatus may perform an adaptive multiple core inverse transform for the current chroma block based on the adaptive multiple core transform information of the corresponding luma block. The adaptive multiple core inverse transform may represent an inverse transform which is performed based on a plurality of transform kernels for the corresponding block (for example, the corresponding luma block or the current chroma block). For example, the decoding apparatus may derive the plurality of transform kernels for the current chroma block based on the adaptive multiple core transform index of the corresponding luma block, and generate the residual sample by inverse-transforming the modified transform coefficients (or primary transform coefficients) based on the plurality of transform kernels. Here, the plurality of transform kernels may be transform kernels indicated by the adaptive multiple core transform index among the discrete cosine transform (DCT) Type 2, the DCT Type 8, the discrete sine transform (DST) Type 1, and the DST Type 7.

Meanwhile, the decoding apparatus may determine whether to perform the adaptive multiple core transform for the current chroma block based on whether to perform the adaptive multiple core transform for the corresponding luma block, that is, whether to generate the residual sample by inverse-transforming the modified transform coefficients (primary transform coefficients) based on the plurality of transform kernels. For example, if the adaptive multiple core transform is performed for the corresponding luma block, the plurality of transform kernels for the current chroma block may be derived based on the adaptive multiple core transform index of the corresponding luma block, and the residual sample may be generated by inverse-transforming the modified transform coefficients (or primary transform coefficients) of the current chroma block based on the plurality of transform kernels. Further, if no adaptive multiple core transform is performed for the corresponding luma block, the residual sample may be generated by inverse-transforming the modified transform coefficients (or primary transform coefficients) of the current chroma block based on the DCT type 2. An adaptive multiple core transform flag of the corresponding luma block representing whether the modified transform coefficients (or primary transform coefficients) of the corresponding luma block are inversely transformed based on the plurality of transform kernels may be derived. That is, it is possible to determine whether to perform the adaptive multiple core transform for the current chroma block based on the adaptive multiple core transform flag of the corresponding luma block. The adaptive multiple core transform flag may represent whether the modified transform coefficients (or primary transform coefficients) of the corresponding luma block are inversely transformed based on the plurality of transform kernels.

Specifically, for example, the decoding apparatus may derive the adaptive multiple core transform flag of the corresponding luma block, and determine whether to generate the residual sample by inverse-transforming the modified transform coefficients (or primary transform coefficients) based on the plurality of transform kernels based on the adaptive multiple core transform flag. When the adaptive multiple core transform flag represents that the modified transform coefficients (or primary transform coefficients) of the corresponding luma block are inversely transformed based on the plurality of transform kernels, the plurality of transform kernels for the current chroma block may be derived based on the adaptive multiple core transform index of the corresponding luma block, and the residual sample may be generated by inverse-transforming the modified transform coefficients (or primary transform coefficients) of the current chroma block based on the plurality of transform kernels. Further, when the adaptive multiple core transform flag represents that no modified transform coefficients (or primary transform coefficients) of the corresponding luma block are inversely transformed based on the plurality of transform kernels, the residual sample may be generated by inverse-transforming the modified transform coefficients (or primary transform coefficients) of the current chroma block based on the DCT type 2. That is, if the value of the adaptive multiple core transform flag is 1, the plurality of transform kernels for the current chroma block may be derived based on the adaptive multiple core transform index of the corresponding luma block, and the residual sample may be generated by inverse-transforming the modified transform coefficients (or primary transform coefficients) of the current chroma block based on the plurality of transform kernels. If the value of the adaptive multiple core transform flag is 0, the residual sample may be generated by inverse-transforming the modified transform coefficients (or primary transform coefficients) of the current chroma block based on the DCT type 2.

The decoding apparatus generates a reconstructed sample based on the predicted sample and the residual sample (S1030). The decoding apparatus may generate the reconstructed sample by adding the predicted sample and the residual sample, and generate a reconstructed picture based on the reconstructed sample. Thereafter, as described above, the decoding apparatus may apply an in-loop filtering procedure such as deblocking filtering and/or SAO procedure to the reconstructed picture in order to improve subjective/objective image quality, if necessary.

According to the present disclosure described above, it is possible to perform the transform of the current chroma block based on the transform information of the corresponding luma block having the same block structure, thereby reducing the amount of bits used for transforming the current chroma block, and improving the overall coding efficiency.

Further, according to the present disclosure, it is possible to perform the linear interpolation prediction for the current chroma block based on whether to perform the linear interpolation prediction for the corresponding luma block having the same block structure, thereby reducing the amount of bits used for predicting the current chroma block, and improving the overall coding efficiency.

In the aforementioned embodiment, the methods are described based on the flowcharts as a series of steps or blocks, but the present disclosure is not limited to the order of steps, and a certain step may occur in different order from or simultaneously with a step different from that described above. Further, those skilled in the art will understand that the steps shown in the flowchart are not exclusive and other steps may be included or one or more steps in the flowcharts may be deleted without affecting the scope of the present disclosure.

The aforementioned method according to the present disclosure may be implemented in the form of software, and the encoding apparatus and/or the decoding apparatus according to the present disclosure may be included in the apparatus for performing image processing of, for example, a TV, a computer, a smartphone, a set-top box, a display device, and the like.

When the embodiments in the present disclosure are implemented in software, the aforementioned method may be implemented as a module (process, function, and the like) for performing the aforementioned function. The module may be stored in a memory and executed by a processor. The memory may be located inside or outside the processor, and may be coupled with the processor by various well-known means. The processor may include application-specific integrated circuits (ASICs), other chipsets, logic circuits, and/or data processing devices. The memory may include a read-only memory (ROM), a random access memory (RAM), a flash memory, a memory card, a storage medium and/or other storage devices.

What is claimed is:

1. A video decoding method performed by a decoding apparatus, comprising:
obtaining transform coefficients and information about an intra prediction mode of a current chroma block;
generating a predicted sample based on the intra prediction mode of the current chroma block;
generating a residual sample using the transform coefficients of the current chroma block based on transform information of a corresponding luma block of the current chroma block; and
generating a reconstructed sample based on the predicted sample and the residual sample.

2. The video decoding method of claim 1, wherein the generating of the residual sample by using the transform coefficients of the current chroma block based on the transform information of the corresponding luma block of the current chroma block comprises:
deriving a non-separable secondary transform (NSST) index of the corresponding luma block; and
generating modified transform coefficients by inverse-transforming the transform coefficients of the current chroma block based on a non-separable transform matrix indicated by the non-separable secondary transform index.

3. The video decoding method of claim 2, wherein a flag representing whether to use the non-separable secondary transform index of the corresponding luma block is obtained through a bitstream,
wherein when the flag represents that the non-separable secondary transform index of the corresponding luma block is used, the non-separable secondary transform index of the corresponding luma block is derived, and
wherein when the flag represents that no non-separable secondary transform index of the corresponding luma block is used, the non-separable secondary transform index of the current chroma block is obtained through the bitstream.

4. The video decoding method of claim 2, wherein the generating of the residual sample by using the transform coefficients of the current chroma block based on the transform information of the corresponding luma block of the current chroma block further comprises:
deriving a plurality of transform kernels for the current chroma block based on an adaptive multiple core transform index of the corresponding luma block; and
generating the residual sample by inverse-transforming the modified transform coefficients based on the plurality of transform kernels, and
wherein the plurality of transform kernels are transform kernels indicated by the adaptive multiple core transform index among a discrete cosine transform (DCT) type 2, a DCT type 8, a discrete sine transform (DST) type 1, and a DST type 7.

5. The video decoding method of claim 4, wherein the generating of the residual sample by using the transform coefficients of the current chroma block based on the transform information of the corresponding luma block of the current chroma block further comprises:
deriving an adaptive multiple core transform flag of the corresponding luma block; and
determining whether to generate the residual sample by inverse-transforming the modified transform coefficients based on the plurality of transform kernels based on the adaptive multiple core transform flag, and
wherein the adaptive multiple core transform flag represents whether the modified transform coefficients of the corresponding luma block are inversely transformed based on the plurality of transform kernels.

6. The video decoding method of claim 5, wherein when the adaptive multiple core transform flag represents that the modified transform coefficients of the corresponding luma block are inversely transformed based on the plurality of transform kernels, a plurality of transform kernels for the current chroma block are derived based on the adaptive multiple core transform index of the corresponding luma block, and the residual sample is generated by inverse-transforming the modified transform coefficients of the current chroma block based on the plurality of transform kernels, and
wherein when the adaptive multiple core transform flag represents that no modified transform coefficients of the corresponding luma block are inversely transformed based on the plurality of transform kernels, the residual sample is generated by inverse-transforming the modified transform coefficients of the current chroma block based on the DCT type 2.

7. The video decoding method of claim 1, wherein the generating of the predicted sample based on the intra prediction mode of the current chroma block comprises:
deriving neighboring samples of the current chroma block;
determining whether to perform linear interpolation prediction for the current chroma block based on whether to perform the linear interpolation prediction for the corresponding luma block; and
generating the predicted sample of the current chroma block by performing the linear interpolation prediction, when it is determined that the linear interpolation prediction is performed for the current chroma block.

8. The video decoding method of claim 7, wherein the generating of the predicted sample of the current chroma block by performing the linear interpolation prediction comprises:
deriving a first reference sample which is positioned in a prediction direction of the intra prediction mode and a second reference sample which is positioned in a direction opposite to the prediction direction based on the predicted sample among the neighboring samples; and
deriving the predicted sample through interpolation of the first reference sample and the second reference sample.

9. The video decoding method of claim 7, wherein when the linear interpolation prediction is performed for the corresponding luma block, it is determined that the linear interpolation prediction is also performed for the current chroma block, and
wherein when no linear interpolation prediction is performed for the corresponding luma block, it is determined that no linear interpolation prediction is performed for the current chroma block either.

10. The video decoding method of claim 7, wherein whether to perform the linear interpolation prediction for the current chroma block is determined based on a linear interpolation prediction flag of the corresponding luma block, and
wherein the linear interpolation prediction flag represents whether to perform the linear interpolation prediction for the corresponding luma block.

11. The video decoding method of claim 1, wherein when block split structures of the current chroma block and the corresponding luma block are the same, the residual sample of the current chroma block is generated by using the transform coefficients of the current chroma block based on the transform information of the corresponding luma block of the current chroma block.

12. A decoding apparatus performing video decoding, the decoding apparatus comprising:
an entropy decoder configured to obtain transform coefficients and information about an intra prediction mode of a current chroma block;
a predictor configured to generate a predicted sample based on the intra prediction mode of the current chroma block, and to generate a residual sample by using the transform coefficients of the current chroma block based on transform information of a corresponding luma block of the current chroma block; and
a reconstructor configured to generate a reconstructed sample based on the predicted sample and the residual sample.

13. The decoding apparatus of claim 12, wherein the predictor derives a non-separable secondary transform (NSST) index of the corresponding luma block, and generates modified transform coefficients by inverse-transforming the transform coefficients of the current chroma block based on a non-separable transform matrix indicated by the non-separable secondary transform index, and
wherein the non-separable transform matrix is a matrix comprising two transform kernels.

14. The decoding apparatus of claim 13, wherein the predictor derives a plurality of transform kernels for the current chroma block based on an adaptive multiple core transform index of the corresponding luma block, and generates the residual sample by inverse-transforming the modified transform coefficients based on the plurality of transform kernels, and
wherein the plurality of transform kernels are transform kernels indicated by the adaptive multiple core transform index among a discrete cosine transform (DCT) type 2, a DCT type 8, a discrete sine transform (DST) type 1, and a DST type 7.

15. The decoding apparatus of claim 14, wherein the predictor derives an adaptive multiple core transform flag of the corresponding luma block, and determines whether to generate the residual sample by inverse-transforming the modified transform coefficients based on the plurality of transform kernels based on the adaptive multiple core transform flag, and
wherein the adaptive multiple core transform flag represents whether the modified transform coefficients of the corresponding luma block are inversely transformed based on the plurality of transform kernels.
